(19) United States
(12) Patent Application Publication
(10) Pub. No.: US 2026/0145109 A1
(43) Pub. Date: May 28, 2026

(54) A POWDER PAINT INJECTOR FILTER SYSTEM BASED ON THE VENTURI PRINCIPLE

(71) Applicant: SISTEM TEKNIK MAKINA SANAYI VE TICARET ANONIM SIRKETI, Konak, Izmir (TR)

(72) Inventors: Deniz TÜRKÜN, Menderes, Izmir (TR); Serdar KAYA, Menderes, Izmir (TR); Asejan ÖZDEN, Menderes, Izmir (TR); Arda HEPÇETINER, Menderes, Izmir (TR)

(21) Appl. No.: 19/123,297

(22) PCT Filed: Jun. 6, 2024
(86) PCT No.: PCT/TR2024/050614

§ 371 Date: Apr. 22, 2025

(30) Foreign Application Priority Data
Jun. 6, 2023 (TR) 2023/006599

(51) Int. Cl. B01D 46/24; B01D 46/00; B05B 7/14

(52) U.S. Cl. CPC B01D 46/2403; B01D 46/0012; B01D 46/0017; B05B 7/1472

(57) ABSTRACT

The present invention relates to a powder paint injector (1) operating on the venturi principle, having a filter system (20) which passes air with its microporous part (25) but filters the powder paint (E1), and at the same time controls the direction of the air (A1, B1) in the powder paint injector (1) with a flexible seal (24) providing one-way air passage.

### Technological Field

The present invention relates to powder paint injectors for transferring powder paint sucked from a tank or reservoir under vacuum to a powder paint gun.

The present invention relates to the filter systems in powder paint injectors.

### STATE OF THE ART

The vacuum environment required for the suction of the powder paint is obtained by the venturi principle. In the Venturi principle, when the fluid moving at high speed and in a narrow cross-section with vacuum power is directed first to a narrow and then to a wide cross-section, negative pressure occurs in the narrowest region. This negative pressure acts as a drive for the transfer of substances. The pressurised fluid in powder paint injectors is air. The material vacuumed and transferred is powder paint.

Powder paint injectors used in the industry, based on the venturi principle; generally suck the powder paint from a reservoir through a channel or a pipe or a hose by means of a vacuum force created by the venturi effect inside the injector. In powder paint injectors, the way in which the air is sent to the nozzle that creates the venturi effect is called the main air, and the air that supports the progress of the sucked paint in the powder paint hose is called auxiliary air.

Powder paint injectors are connected to devices that manage the air flow rate and/or pressure. Generally, from these devices, main air is sent to the nozzle area for venturi effect and auxiliary air is sent to ensure the progress of the powder paint in the device. Changing the amount of main and auxiliary air in the device causes more or less paint air mixture to be sent to the powder spray gun to which the injector is connected by a hose. In this way, the powder paint-air ratio in the application is provided at the desired level.

There are valves in the device that work only with air and should not come into contact with powder paint. These valves will malfunction and become dysfunctional if they come into contact with powder paint. For this reason, there should be no powder paint movement from the main and/or auxiliary air sections towards the device that sends air to the auxiliary and main air sections of the injector by adjusting the air flow and/or pressure.

In powder paint processes; when there is a need to switch from a paint of a certain colour to another paint, it is necessary to clean the injector from the previous powder paint. This purification process is called cleaning in powder paint applications. It is undesirable for the powder paint remaining in the inner parts of the injector to mix with the new paint to be applied.

In order to remove the paint remaining in the injector when the cleaning process is performed, much higher pressure air is sent from the main air and/or auxiliary air and/or the chamber where the injector sucks the powder paint, compared to the normal working condition. Meanwhile, the powder paint in the injector tries to move towards the powder paint device through the injector hose connection sections. The movement of the powder paint towards the device must be restricted as it will damage the powder paint device.

Since the valves inside the powder paint device should only work with air and their functions will be impaired if these valves come into contact with powder paint, powder paint should never move towards the device. In various applications in the industry, this problem has been tried to be solved by adding a filter element.

The patent document numbered EP0718047B1 encountered in the literature search is related to a powder paint injector. The document describes an air injector for the dust feeder in a powder paint system with a dust barrier with a filter element made of microporous material. Microporous material is permeable to air but not permeable to coating powder. The powder barrier is said to prevent the coating powder from entering the air supply path in a direction opposite to the direction of air flow, and the powder barrier also allows for rapid colour change in the cleaning process without the need to remove the air injector. However, the mentioned document does not contain a solution that can prevent the paint from going to the supply unit in the powder paint device in case of damage to the internal microporous filters and/or fix the air flow direction in one direction under all conditions.

The patent document U.S. Pat. No. 11,446,683B2, which was encountered in the literature search, is related to the venturi nozzle arrangement used in powder injectors. The document does not mention any recommendations regarding the air intakes needed for injector operation. There is no mention of a structure that can allow unidirectional movement of air in the air inlets.

The patent document numbered U.S. Pat. No. 6,105,787A encountered in the literature search is related to a filtering device. In the document, a porous filter placed inside a plastic structure separates the internal and external volume. In this way, liquid fluids are kept outside the filter. The document does not mention a solution to prevent the passage of unfiltered product to the unwanted side in case of damage to the filter and/or to ensure that the flow is unidirectional.

The patent document numbered U.S. Pat. No. 9,636,695, which was encountered in the literature search, is related to the powder paint injector based on the venturi principle. In the method described in the document, no filter element is used at the inlets of the powder paint injectors. It comprises a protection valve containing a movable, circular ball. In addition, in the relevant publication, there is no mention of a porous filter in the air inlet area that will make the venturi effect and/or any solution that allows unidirectional movement of air.

As can be seen, in the known art, a number of filtering techniques are used in powder paint injectors. In order to control the path of the powder paint in the system, it is necessary to control the direction of the air. The products on the market do not have structures to ensure unidirectional movement of air.

As a result, there is a need for a new powder paint injector in which the known state of the art is overcome and its disadvantages are eliminated.

### BRIEF DESCRIPTION OF THE INVENTION

The present invention is a powder paint injector which exceeds the state of the art, eliminates the disadvantages and has some additional features.

The object of the present invention is to provide a new powder paint injector that passes air with its microporous part but filters the powder paint, and at the same time controls the direction of the air in the injector with a flexible seal that provides unidirectional air transmission.

Another object of the present invention is to provide a new powder paint injector which prevents contact of the valves operating in the system with the powder paint.

Another object of the present invention is to provide a new powder paint injector which prevents the movement of powder paint from the injector to the powder paint device.

A further object of the present invention is to provide a new powder paint injector comprising measures to ensure that the powder paint and air move through the system in a preferred path.

### DESCRIPTION OF THE FIGURES

The present invention will be described with reference to the accompanying drawings, thus the characteristics of the invention will be understood clearly. However, the aim of this is not to limit the invention with such certain embodiments. On the contrary, it is aimed to cover all alternatives, amendments and equivalents which may be contained in the field defined by the accompanying claims. It is to be understood that the details shown are only shown for the sake of illustrating the preferred embodiments of the present invention and presented for both illustrating the methods and for providing description of the rules of the invention and the conceptual features of the invention to be easily understood. In these figures;

FIG. 1 View showing the general working principle of the powder paint injector of the present invention.

FIG. 2 a View showing the assembly of the injector system into the injector housing.

FIG. 2b View expressing that the powder paint injector subject to the invention can be easily disassembled with the help of the protrusion that facilitates its connection with human hands during the assembly of the injector system into the injector housing.

FIG. 3 Cross-sectional view of the powder paint injector of the present invention.

FIG. 4 a Cross-sectional view of the filter system used in the powder paint injector of the present invention.

FIG. 4b Bottom perspective view of the filter system used in the powder paint injector of the present invention.

FIG. 4c Upper perspective view of the filter system used in the powder paint injector of the present invention.

FIG. 5 Exploded cross-sectional view of the powder paint injector of the present invention.

The figures which enable to clarify this invention are enumerated as mentioned the attached figure and they are given with their names herein below.

### DESCRIPTION OF THE REFERENCES

1. Powder paint injector
10. Injector body
   101. Injector paint inlet path
   102. Injector body delivery path
      1021. Injector body delivery path axis
   103. Injector body gripping protrusion
11. Circular shaped clamping part
12. Filter system clamping part
   111. Main air part engagement section
      1211. Filter system clamping part engagement section
      1212. Clamping part filter system path
      1213. Clamping part air inlet path
   111. Auxiliary air part engagement section
20. Filter system
21. Upper part
   211. Circular section flexible part top
      2111. Circular section flexible part upper housing
   212. Upper part air inlet path
22. Bottom part
   221. Bottom part airway gap
   211. Circular section flexible part bottom
      2221. Circular section flexible part bottom housing
23. Middle part
   211. Circular section flexible part middle
      2311. Circular section flexible part middle housing
   232. Flexible seal airway gap
24. Flexible seal
25. Microporous part
30. Powder delivery system
   A. Main air filter system path
      A1. Main air
      A2. Main air filter system housing
         A21. Main air filter system housing axis
   A. Auxiliary air filter system path
      B1. Auxiliary air
      B2. Auxiliary air filter system housing
         B21. Auxiliary air filter system housing axis
   C. Powder paint device
   D. Filter housing angle
   E. Chamber
      E1. Powder paint
      E2. Powder paint gun
      E3. Powder paint hose
      E4. Injector housing
   F. Human hand
      F1. Finger

### DESCRIPTION OF THE INVENTION

In this detailed description, the inventive powder paint injector (1) is described by means of examples only for clarifying the subject matter such that no limiting effect is created.

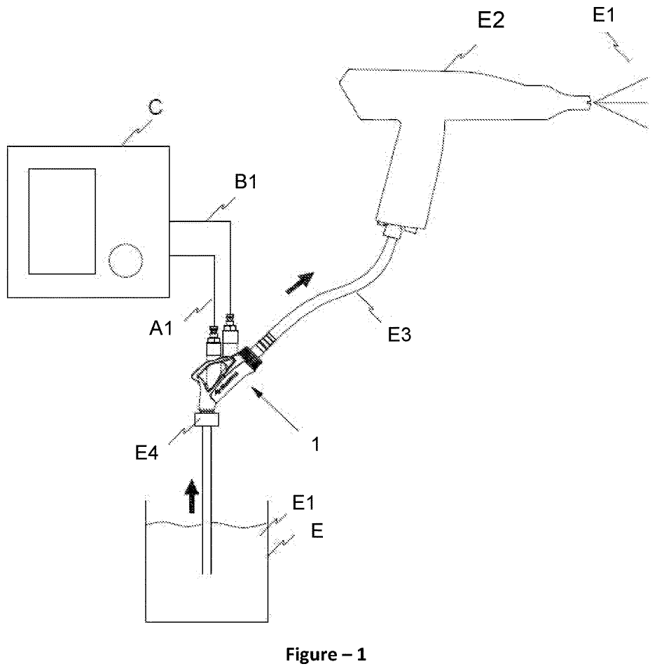

FIG. 1 shows a view explaining the intended use of the powder paint injector (1) of the present invention. Accordingly, the powder paint injector (1) takes the powder paint (E) in a chamber (E) and transfers the same to the powder paint gun (E2) via the powder paint hose (E3). The connection of the powder paint injector (1) to the chamber (E) is provided by the injector housing (E4). In the invention, powder paint (E1) is defined as a kind of special chemical substance in powder form that is used for coating purposes in various applications. Powder paint gun (E2) is the tool that enables the application of powder paint (E1). The powder paint injector (1) subject to the invention works on the venturi principle. As it is known, main air (A1) and auxiliary air (B1) are used in powder paint injectors (1) that work with the venturi principle. The main air (A1) ensures that the powder paint (E1) is sucked from the chamber (F) and sent to the powder paint gun (E2) with the effect of the venturi. Auxiliary air (B1) provides support in delivering the powder paint-air mixture created in the powder paint injector (1) based on the venturi principle to the powder paint gun (E2). In other words, while the main air (A1) draws powder paint (E1) from the chamber (E), the amount of powder paint (E1) desired to be delivered to the powder paint gun (E2) is determined by the auxiliary air (B1). By changing the amounts of main air (A1) and auxiliary air (B1), the amount of powder paint (E1) transferred to the powder paint gun (E2) can be increased or decreased. In the invention, main air (A1) is supplied to the main air filter system path (A) in the powder paint injector (1), and auxiliary air (B1) is supplied to the auxiliary air filter system path (B). The supply of main air (A1) and auxiliary air (B1) is provided by the powder paint device (C). The powder paint device (C) is a control device which ensures that the main air (A1) and auxiliary air (B1) are sent to the powder paint injector (1) at the desired rate.

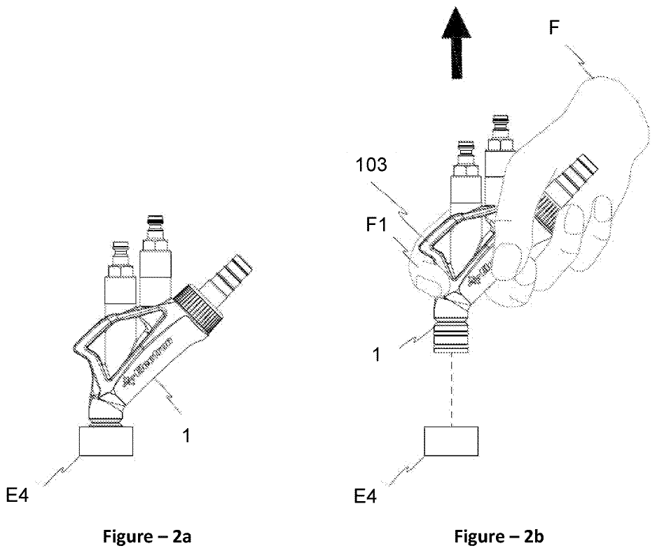

FIG. 2a and FIG. 2b show the view showing the separation of the powder paint injector (1) subject to the invention from the injector housing (E4), which provides its relationship with the chamber (E). Accordingly, the powder paint injector (1) comprises an injector body gripping protrusion (103) on the injector body (10), where the index finger (F1) of the human hand (F) is placed, which increases the gripping ability. When the powder paint injector (1) is grasped by the human hand (F) and pulled upwards, the injector is separated from its housing (E4).

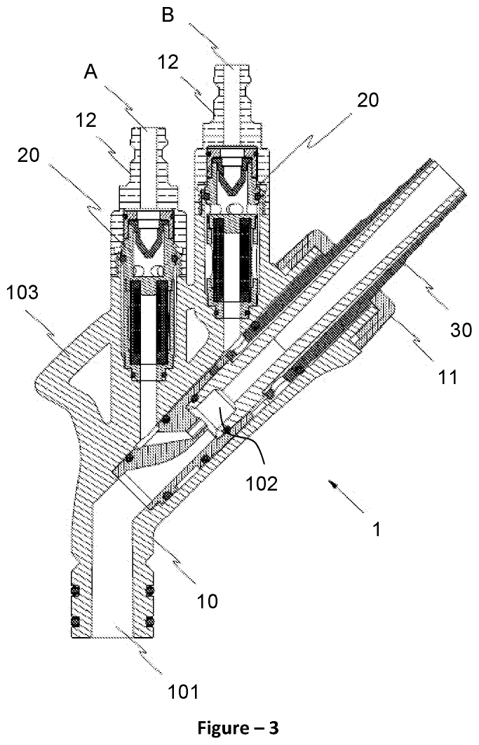

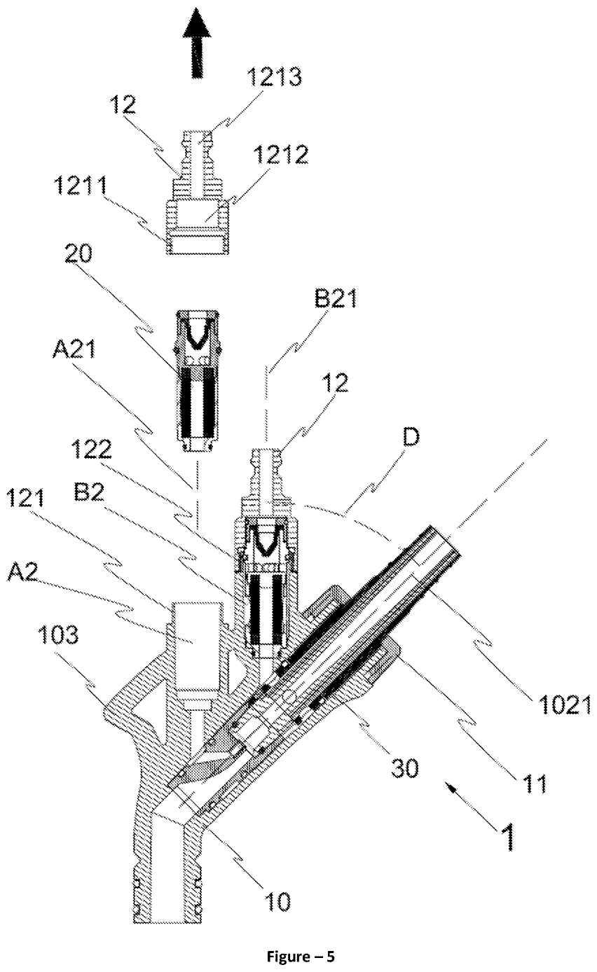

FIG. 3 shows a sectional view of the powder paint injector (1) subject to the invention. Accordingly, in the injector body (10) of the powder paint injector (1), the powder paint (E1) enters the injector paint inlet path (101) and travels along the injector body delivery path (102) in the direction of the injector body delivery path axis (1021). This section is referred to as the powder delivery system (30). The powder delivery system (30) is the part that contains all the parts on the path that the powder paint (E1) and air mixture follows in the powder paint injector (1) until it is transferred to the powder paint hose (E3). It is mounted on the injector body (10) with a circular shaped clamping part (11). This situation can be seen in FIG. 3 and FIG. 5.

A distinctive feature of the invention is the filter system (20) used in the main air filter system path (A) and in the auxiliary air filter system path (B), said filter system (20) comprising a series of measures preventing the return of powder paint (E1) to the powder paint device (C). After the filter system (20) is placed on the main air filter system path (A) and the auxiliary air filter system path (B), it is fixed from the top with the filter system clamping part (12). The filter system clamping part (12), the main air part clamping part (121) and the auxiliary air part clamping part (122) are contacted with the filter system clamping part clamping part (1211), rotationally clamped, and hold the filter system (20) in the main air filter system path (A) and the auxiliary air filter system path (B). The main air (A1) and auxiliary air (B1) sent from the powder paint device (C) to the main air filter system path (A) and the auxiliary air filter system path (B) pass through the clamping part air inlet path (1213) and the clamping part filter system path (1212) and proceed to the filter system (20). In the invention, the same filter system (20) is used both in the main air filter system path (A) and in the auxiliary air filter system path (B). Preferably, it is planned to be used in at least one of these two ways.

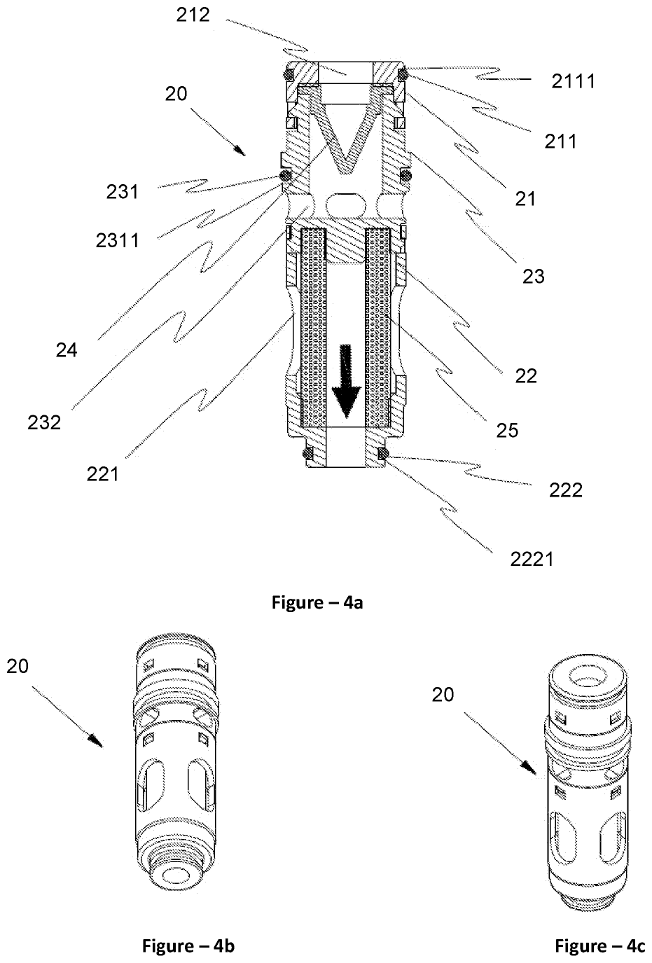

The filter system (20) used in the powder paint injector (1) subject to the invention consists of an upper part (21), a middle part (23) and a lower part (22) as seen in FIG. 4a. There is a flexible seal (24) that provides one-way air passage between the upper part (21) and the middle part (23). Flexible seal (24) is a part made of rubber, silicone or similar material, which provides unidirectional passage of air (A1, B1), which opens the path when the air (A1, B1) moves in one direction and does not allow the movement of air (A1, B1) by closing the path when forced to move in the other direction. The flexible seal (24) is placed in a way that only allows movement towards the injector body (1) from the main air filter system path (A) and/or the auxiliary air filter system path (B). In the invention, there is also a microporous part (25) mounted on the base of the middle part (23) and extending throughout the space within the lower part (22). The microporous part (25) is a filtering medium that is permeable to air (A1, B1) and impermeable to powder paint (E1). Thanks to the use of flexible seal (24) and microporous part (25) in the invention, the powder paint (E1) is prevented from reaching the powder paint device (C) and the valves that provide air (A1, B1) pressure. Even if the microporous part (25) is deformed in some way and fails to fulfil its function, the one-way flexible seal (24) prevents the passage of powder paint (E1) to the powder paint device (C) because it does not allow air (A1, B1) to pass in the direction of the powder paint device (C).

As can be seen in FIG. 4a, the upper part (21) used in the invention comprises a circular section flexible part upper element (211) which provides a seal so that air (A1, B1) can only be transmitted through the upper part air inlet passage (212). The circular section flexible part upper (211) is placed in the circular section flexible part upper housing (2111). The upper part air inlet path (212) in the upper part (21) is an area on the filter system (20), where the air coming from the main air filter system passage (A) and/or the auxiliary air filter system passage (B) is transmitted to the flexible seal (24) providing one-way air passage. The air (A1, B1) coming from the upper part air inlet path (212) passes through the flexible seal (24), the middle part (23) and the microporous part (25) and is transferred to the lower part air path gap (221) in the lower part (22). The lower part airway gap (221) is the area that allows the air (A1, B1) to pass over the lower part (22). In the lower part (22), there is also a circular section flexible lower part (222) element that provides sealing in a way that ensures the delivery of air (A1, B1) only through the lower part airway gap (221). The circular section flexible part lower (222) is placed in the circular section flexible part lower housing (2221). Likewise, in the middle part (23), there is a circular section flexible middle element (231) that provides sealing in a way that ensures the delivery of air (A1, B1) only through the middle part (23). The circular section flexible part is placed in the middle (231) and the circular section flexible part is placed in the middle housing (2311). Additionally, in the middle part (23), there is a flexible seal airway gap (232) that forms the airway part of the flexible seal (24) that provides one-way air passage.

The powder paint injector (1) subject to the invention prevents the passage of powder paint (E1) to the powder paint device (C) with the help of the filter system (20), flexible seal (24) and microporous part (25). The filter system (20) subject to the invention is placed in the main air filter system housing (A2) and the auxiliary air filter system housing (B2) at the filter housing angle (D). Filter housing angle (D) is the 45° angle between the main air filter system housing axis (A21) and/or the auxiliary air filter system housing axis (B21) and the injector body delivery path axis (1021). This angle being 45° improves the air (A1, B1) delivery performance. Depending on preference, it is possible to take a value between 0-90°.

1. A filter system placed in a main air filter path and/or an auxiliary air filter system path in a powder paint injector operating on the Venturi principle, the filter system comprising:
at least one flexible seal in an inlet section of the filter system, which provides one-way air passage to allow movement from the main air filter system path and/or the auxiliary air filter system path towards an injector body; and
at least one microporous part within the filter system, which is a filtering medium that is permeable to air and impermeable to powder paint.

2. A filter system according to claim 1, comprising an upper part a lower part and a middle part joined by interlocking with each other, so that the air coming from the powder paint device is transferred to an injector paint inlet path and/or an injector body delivery path.

3. A filter system according to claim 2, comprising a circular section flexible upper part on the upper part which is sealed so that air is only transmitted through the upper part air inlet path.

4. A filter system according to claim 3, comprising a circular section flexible part upper housing on the upper part in which a circular section flexible part upper element is disposed.

5. A filter system according to claim 2, comprising an upper part air inlet path in the upper part, on the filter system, wherein it delivers air from the main air filter system path and/or the auxiliary air filter system path to the flexible seal for unidirectional air passage.

6. A filter system according to claim 2, comprising a lower part airway gap in the lower part which is a space for air to pass over the lower part.

7. A filter system according to claim 2, comprising a circular section flexible lower part element in the lower part, which provides sealing in a way that ensures the delivery of air only through the lower part airway gap.

8. A filter system according to claim 7, comprising a circular section flexible part lower housing in which a circular section flexible part lower element is disposed.

9. A filter system according to claim 2, comprising a flexible part centre with a circular section in the middle part which seals in such a way that air is only transmitted through the middle part.

10. A filter system according to claim 9, comprising a circular section flexible part centre housing in which a circular section flexible part centre element is disposed.

11. A filter system according to claim 2, wherein in the middle part, a flexible seal airway gap forms the airway part of the flexible seal that provides one-way air passage.

12. A filter system according to claim 1, comprising a filter system arranged in the main air filter system housing and the auxiliary air filter system housing at a filter housing angle of 45°.
